(19) United States
(12) Patent Application Publication
(10) Pub. No.: US 2012/0192099 A1
(43) Pub. Date: Jul. 26, 2012

(54) Disposition of business process management program elements in a single window

(75) Inventors: Antonio Carbonera, Pavia (IT); Paolo Forlani, Milano (IT)

(73) Assignee: PRB SRL, Milano (IT)

(21) Appl. No.: 13/012,817

(22) Filed: Jan. 25, 2011

(51) Int. Cl. G06F 3/048

(52) U.S. Cl. 715/781

(57) ABSTRACT

Disposition of Business Process Management (BPM) program elements in a single window, where all the elements of a BPM program are located, together with all the elements of a personal organization program and together with all the commands needed to start office programs. The user may perform all wanted activities without sending several commands and without crossing several windows thus optimizing time usage and reducing the possibility of errors.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

In the field of informatics, many programs exist whose purpose is to manage business activities and processes; their technical sector, “Business Process Management”, is often abbreviated with the BPM acronym. These programs are used by organizations to coordinate the execution of business processes and of personal activities that are involved in processes. All operators use an informatics BPM program that helps them to manage their daily activities according to their assigned jobs.

Programs of this kind are used in organizations such as banks, insurance companies, government agencies to manage the advance of business items. They allow to eliminate traditionally used sheets, folders and binders replacing them with informatics tools.

Modern BPM programs look like a window in the screen of a computer, where business folders are shown in a list or in a tree structure, often grouped according to their state, for instance “new”, “in progress”, “to deal with”, “approved”, “cleared”, “refused”. When a folder is chosen in the list, all documents contained in the folder are shown in a second list, with all the references needed to identify them.

The operator, using appropriate commands, may display documents, move them from a business folder to another one, add annotations. He may also move a folder from a state to another one, for instance from “to deal with” to “approved”.

In the same field of informatics, also “personal organization programs” exist and are widely used. Programs made according to current technology are presented in the screen of a computer as a window wherein, with appropriate commands, several elements may be shown, such as:
A calendar, with the list of activities due at every date and hour
The list of activities due, but not connected with a date and hour
The list of contacts, with names, mail and e-mail addresses, telephone and fax numbers
The list of messages received, sent and to be sent.

The operator interacts with the program by keying in data, by using the mouse or by moving a stylus on the screen.

Personal organization programs interact with BPM programs, because daily personal activities depend on more general office activities and processes and, on the other side, the advance of business processes is composed of a sum of personal activities.

Finally, in current informatics technology, in a computer many “office document management” programs exist, particularly “text editors”, “spreadsheet programs”, “electronic mail programs” and many others. Also these programs are used daily and are the basis of all office activities.

All the above listed programs are coordinated by the operating system of the computer, that allows the user to start one or more programs by means of a sequence of appropriate commands. For instance, in typical embodiment, to create a new text document:
The user clicks with the mouse on the “start” button
A list is shown where the user chooses the item “all programs” with a click
A second list is shown, where the user chooses “office”
A third list is shown, where the user chooses “text editor”
Now the text editor program is started and it allows the user to create the text.

The above described current technology allows to perform all the wanted activities, but to carry out any of them it is necessary to send several commands and cross several windows. Also, when each new window is opened, the previously opened windows are closed, minimized or covered by the new one. The inexperienced user finds it difficult to remember all the steps needed to perform every operation and also the experienced user has anyway to make a series of steps with the consequence of time waste and possibility of errors.

It can be easily seen that current technology allows to perform all operations, but it does not optimize time usage, it allows a considerable error possibility and does not take the best advantage of the operating and mnemonic capability of the user.

### BRIEF SUMMARY OF THE INVENTION

The invention consists in a particular disposition, in a single window in the screen, of all the elements the user needs for his/her daily activity. Since all lists, documents, commands are available in the same window, the operator does not have to cross many windows and to send many commands for every single operation, with an evident time saving.

There is no necessity to remember cascaded command sequences and to realize the point in the sequence the user is at. Also the possibility of errors is greatly reduced.

### BRIEF DESCRIPTION OF THE SEVERAL VIEWS OF THE DRAWING

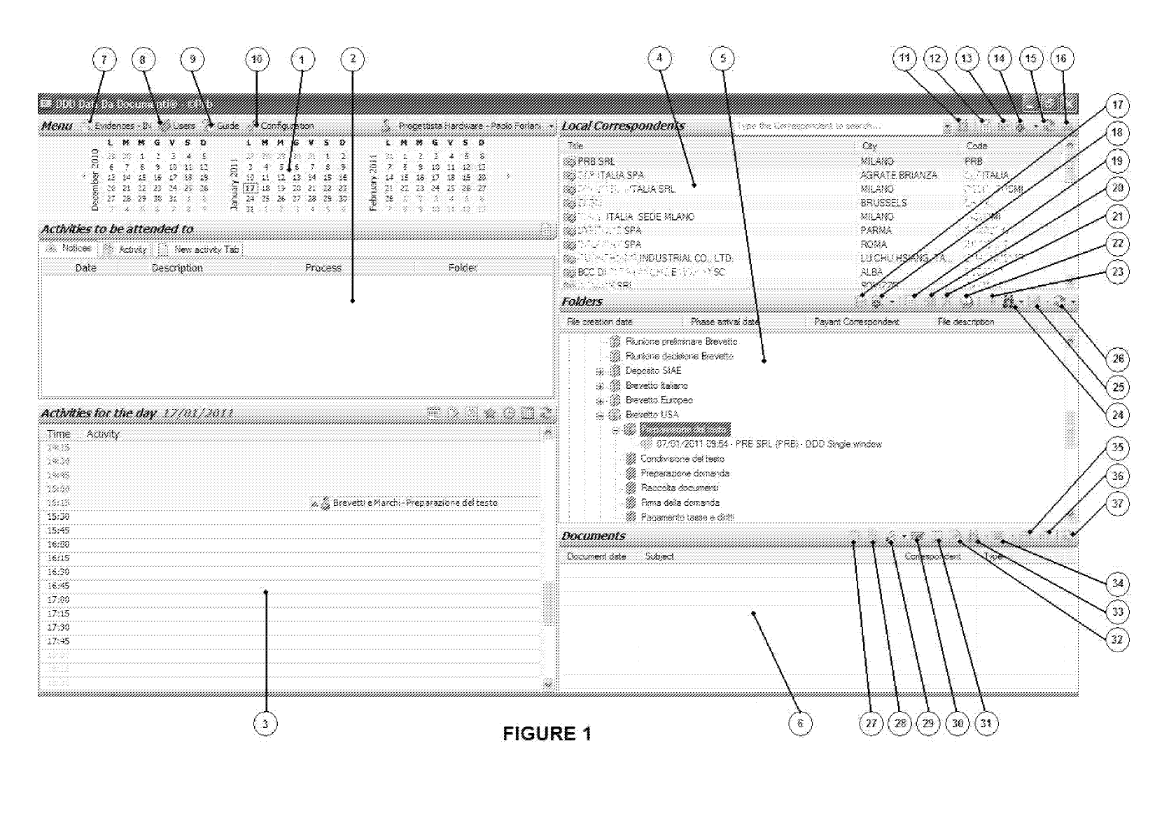

In FIG. 1 it is possible to see the main window of a program made according to the invention.

### DETAILED DESCRIPTION OF THE INVENTION

As shown in FIG. 1, all the elements of a BPM program, all the elements of a personal organization program and all the commands to start usual office programs and activities are displayed in a single window.

The elements in the window are:
A calendar (referenced as 1 in the FIGURE)
A list of due activities (referenced as 2 in the FIGURE)
A list of the activities of the day, where each activity is scheduled for an hour (referenced as 3 in the FIGURE)
A list of personal (local) contacts (referenced as 4 in the FIGURE)
A list of business folders, with a tree organization that also shows the progress state (referenced as 5 in the FIGURE)
A list of documents in business folders, filled whenever a folder is selected (referenced as 6 in the FIGURE)
A number of icons that start activities and programs:
   Icon 7 (Evidences-IN) opens a message management program that allows the user to see received messages and to search for sent and already seen messages
   Icon 8 (Users) shows the list of the users of the application in the same company
   Icon 9 (Guide) shows the manual of the application
   Icon 10 (Configuration) shows the table that allows to see and change the configuration of the program
   Icon 11 (Correspondent search) shows a window used to search for correspondents in the main directory of the company and to transfer some of them to the local contacts list 4
   Icon 12 (Correspondent add) allows to transfer a correspondent to the local contacts list 4
   Icon 13 (Change correspondent display mode) allows to show correspondents with different grouping criteria
   Icon 14 (Correspondent expand-close) allows to expand or close the visualization of secondary trees in the correspondent list
   Icon 15 (Reload correspondent) reloads the list of correspondents in case of modifications
   Icon 16 (Correspondent management) allows to modify correspondent data in the main directory of the company
   Icon 17 (Select organization areas) allows to display the list of business folders with different grouping criteria
   Icon 18 (Folders expand-close) allows to expand or close the visualization of secondary trees in the folders list
   Icon 19 (Create new folder) allows to create a new business folder
   Icon 20 (Move folder) moves the selected business folder to its next phase
   Icon 21 (Delete folder) deletes the selected business folder
   Icon 22 (View last folders) shows the list of recently opened folders
   Icon 23 (Mark folder as urgent) marks the folder when the user has to act on it urgently
   Icon 24 (Find folders) allows to search a folder knowing partial data about it
   Icon 25 (Create stats) opens a window where the user may create statistics about one or more business folders
   Icon 26 (Update processes) reloads the list of business folders in case of modifications
   Icon 27 (View documents in the linked folders) shows or hides documents present in folders linked to the current one
   Icon 28 (Show deleted documents) shows documents that have been deleted in the folder
   Icon 29 (Create document) allows to create a new document: it opens the text editor window on top of the main one
   Icon 30 (Quick send) allows to rapidly send a document
   Icon 31 (Browse documents) shows all documents in the folders, one after the other, with no need to choose and open them singularly
   Icon 32 (Document form scanner) allows to input a document from a document scanner
   Icon 33 (Retrieve documents) allows to search a document knowing partial data about it
   Icon 34 (General forms) allows to create a form: it opens the text editor window on top of the main one, and preloads a standard form ready to be filled
   Icon 35 (PC file documents) allows to insert into the business folder a document already present in the computer
   Icon 36 (Audio document) allows to insert an audio clip into the business folder
   Icon 37 (Reload documents) reloads the list of document in the selected business folder in case of modifications.

To perform operations, the user clicks, selects or drags with the mouse the elements of the window. The window is never closed and is always available for new commands. At most one other window is opened for operations; this window can partially overlap the main one, but no more than two windows are opened under any circumstance.

For instance, to create a new text document, insert it in the appropriate business folder and send it to a correspondent, the user has to perform only a few simple actions:
Select a business folder in list 5 by clicking on it
Press icon 29 to start the editor
Write the text
Drag the wanted addressee from correspondent list 4 to the text
Click the “send” icon in the text editor program
Confirm the send operation.

In this example, the user does not need to know the name and the location of the text editor program and of the mail transmission one: they are started by the main application when needed, without the need for any other effort. The same happens for all the daily activities: there is no need to know all the programs involved and the user needs only to click icons or drag elements in the main window.

This organization solves the above mentioned problems, because it allows a big saving of time, considerably reduces the error possibility, simplifies operation and releases the stress on operating and mnemonic capability of the user.

The above description is related to a particular embodiment of the invention with the purpose of explaining its characteristics; many other embodiments and command placements are possible, based on the type of the activities the user has to do, on the features of the computer and of its operating system, and also on aesthetical preferences.

Although the invention has been described in detail for the purpose of illustration only, it is understood that such detail is solely for that purpose and that many variations, changes, additions and substitutions can be made therein by those of ordinary skill in the art without departing from the spirit and scope of the invention, as defined by the following claims, including all equivalents thereof.

The U.S. Pat. No. 7,346,848 (Ruthfield and others) proposes another possible solution to this problem, but it is quite different from the one given here. In the solution proposed by Ruthfield, different activities are alternatively presented, one after the other, in the same screen space and the window is always only one. In the patent described here, all functionalities are available together in the same screen and a second window can partially overlap the main one to show the details of a particular functionality; no more than two windows are displayed.

1. Disposition of elements of a Business Process Management (BPM) program, where all the elements are located in a single window on the screen.

2. Disposition of elements of a BPM program according to claim 1, where the elements are: list of the business folders and of their status; list of the documents in each folder; list of the correspondents; list of the internal users.

3. Disposition of elements of a BPM program according to claim 1, where the single window also includes all the elements of a personal organization program: calendar; list of due activities; list of the activities of the day with their planned hour.

4. Disposition of elements of a BPM program according to claim 1, where the single window also includes all the commands, represented by icons, that allow to directly start office programs such as: text editor; spreadsheet program; message handling program.

5. Disposition of elements of a BPM program according to claim 1, where the single window is always displayed on the screen also when other functions are opened.

6. Disposition of elements of a BPM program according to claim 1, where at most another window is opened over the first one when other operations are started.
